(19) United States
(12) Patent Application Publication
(10) Pub. No.: US 2012/0190263 A1
(43) Pub. Date: Jul. 26, 2012

(54) SOFT, FLEXIBLE NONWOVEN CHOPPED STRAND MAT FOR USE IN PULTRUSION PROCESSES

(75) Inventor: William Hager, Westerville, OH (US)

(73) Assignee: OCV Intellectual Capital ,LLC, Toledo, OH (US)

(21) Appl. No.: 13/388,770

(22) PCT Filed: Aug. 6, 2010
(86) PCT No.: PCT/US2010/044658

§ 371 Date: Apr. 4, 2012

Related U.S. Application Data
(60) Provisional application No. 61/231,876, filed on Aug. 6, 2009.

(51) Int. Cl. B32B 17/04; D21H 17/37; B32B 5/26; C08L 33/08

(52) U.S. Cl. 442/331; 524/562; 162/164.7

(57) ABSTRACT

Wet-laid, non-woven chopped strand mats that are soft, flexible, and resistant to styrene are provided. The mats are at least partially coated with a binder composition that includes a thermosetting binder resin, a silane coupling agent, a hydrocarbon-based antifoaming agent. Optionally, a crosslinking agent, such as a resin-based crosslinking agent, may be included in the composition. In one or more embodiments, the chopped strand mats are formed of chopped glass fibers having diameters from about 5 to about 30 microns and lengths from about 0.5 to about 2.0 inches. The softness and flexibility of the chopped strand mats enable the formation of pultruded products having complex shapes. Additionally, the resistance to styrene monomers provided by the binder composition makes the inventive mats particularly suitable for pultrusion processes.

### CROSS-REFERENCE TO RELATED APPLICATIONS

This application is related to and claims domestic priority benefits from U.S. Provisional Patent Application Ser. No. 61/231,876 entitled “Soft, Flexible Nonwoven Chopped Strand Mat For Use In Pultrusion Processes” filed Aug. 6, 2009, the entire content of which is expressly incorporated herein by reference in its entirety.

### TECHNICAL FIELD AND INDUSTRIAL APPLICABILITY OF THE INVENTION

The present invention relates generally to nonwoven fibrous mats, and more particularly, to nonwoven chopped strand mats for use in pultrusion processes that are soft, flexible, and resistant to styrene.

### BACKGROUND OF THE INVENTION

Glass fibers are useful in a variety of technologies, and may be used in the form of continuous or chopped filaments, strands, rovings, woven fabrics, nonwoven fabrics, meshes, and scrims to reinforce polymers. Reinforced polymeric composites can be formed from a polymeric matrix material, reinforcing material, or any other desired components in a variety of ways. Such composites are formed using glass fiber reinforcements which provide dimensional stability and excellent mechanical properties to the resulting composites. For example, glass fibers provide dimensional stability as they do not shrink or stretch in response to changes in atmospheric conditions. Further, glass fibers have high tensile strength, heat resistance, moisture resistance, and high thermal conductivity.

Glass rovings and/or glass mats are commonly used in pultrusion processes to form pultruded parts. Generally, pultrusion involves impregnating continuous rovings and/or continuous roving/mat combinations with a suitable resin material and passing the impregnated roving and/or mat through a heated die. The rovings are impregnated with a liquid resin material to wet or coat the individual fibers within the roving. The coated fibers and mat are then consolidated and passed through a pultrusion die where the fibers and mat are formed into a desired shaped, heated, and the resin is cured to hold the fibers and mat together. The composite part exiting the heated die is then cut to a desired length. In this manner, the continuous roving is impregnated with a polymer resin, and the resin and fibers are shaped into the form of the composite.

The continuous nature of the pultrusion process advantageously enables composites of any desired length to be produced. However, there are numerous problems associated with pultrusion processes. One problem lies within the resin bath. One component in the resin system that is used in pultrusion includes thermoset resins, which generally require the use of volatile unsaturated monomers such as styrene and/or methyl methacrylate. Styrene is a potent solvent, and can easily swell and degrade a binder located on the reinforcement mat. Such degradation of the binder can cause the reinforcement mat to weaken and be unable to withstand the strong pulling forces encountered in a pultrusion process.

Another problem associated with the pultrusion process is the binder on the reinforcement mat. Conventionally, continuous filament mats (CFM) coated with a binder are used in pultrusion processes. Although continuous filament mats are flexible, conformable, and have an excellent resistance to styrene, they possess several drawbacks. For instance, continuous filament mats are expensive to manufacture because fabrication of the continuous filament mats occurs at a slow rate, that is, 50-75 feet per minute (fpm). Additionally, the utilization of continuous filament mats yields laminates that have a poor surface finish due to the large strands of glass that form the mats. Further, continuous filament mats are dense and add weight to the final part, which may be an undesirable feature.

Nonwoven chopped strand mats coated with a binder may also be used in pultrusion processes. These mats are less expensive to manufacture than continuous filament mats because fabrication occurs at a faster rate (that is, 500-1500 fpm). Additionally, nonwoven mats are essentially fully dispersed fibers, which give the pultruded part a smoother appearance than continuous filament mats. In addition, nonwoven mats are advantageously “space filling” without adding a lot of weight to the laminate. Despite these positive attributes, nonwoven mats are very stiff and therefore difficult to form into complex shapes. Additionally, the stiffness of the mats causes a feel that may be undesirable to customers.

Although pultrusion processes possess many desirable attributes, such as the ability to form elongated structures of uniform cross-section, there remain features and/or items associated with the process that need to be improved upon. Accordingly, there exists a need in the art for a softer, more flexible mat for use in a pultrusion process that is also resistant to styrene.

### SUMMARY OF THE INVENTION

In one exemplary embodiment of the present invention, a binder composition including a thermoset resin, a silane coupling agent, and a hydrocarbon-based antifoaming agent is provided. Optionally, a crosslinking agent is included in the binder composition. The addition of one or more crosslinking agent to the binder composition enhances resistance to styrene monomers, thereby enabling the mat to withstand the high pulling forces encountered in a pultrusion process. In exemplary embodiments, the binder resin is an acrylic polymer and/or a styrene acrylate, the silane coupling agent is a methacryloxy silane, and the antifoaming agent is a hydrocarbon oil antifoaming agent. Additionally, the crosslinking agent may be a resin-based crosslinking agent such as a polyacrylic acid/glycerin mixture.

In another exemplary embodiment, wet-laid chopped strand mats for use in pultrusion processes are provided. The wet-laid mats are formed of a plurality of randomly dispersed chopped reinforcement fibers bound together by the binder composition set forth above. The chopped strand mat is soft and flexible to enable the formation of pultruded products having complex shapes. In one or more embodiments of the invention, the chopped strand mats are formed of chopped glass fibers having diameters from about 5 to about 30 microns and lengths from about 0.5 to about 2.0 inches.

In a further exemplary embodiment, a pultruded part including (1) a plurality of rovings impregnated with a thermosetting resin and (2) a wet-laid nonwoven chopped strand mat having thereon a binder composition as set forth above is provided. The plurality of ravings and the wet-laid nonwoven chopped strand mat are consolidated and pultruded into a complex shape. The binder composition provides a resistance to styrene monomers present in the thermosetting resin of pultrusion processes and a flexibility to the chopped stand mat to enable the formation of complex, pultruded parts.

In yet another exemplary embodiment of the present invention, the inventive chopped strand mats are resistant to styrene monomers present in the resin utilized in pultrusion processes.

In a further exemplary embodiment of the present invention, the flexibility of the inventive mats enables the formation of pultruded products having complex shapes.

In another exemplary embodiment of the present invention, the binder compositions may be utilized in a conventional wet chopped strand mat forming process without having to change process parameters.

In yet another exemplary embodiment of the present invention, the fibers forming the chopped strands are glass fibers that have diameters ranging from about 10 to about 20 microns and a chopped length from about 1.0 to about 1.5 inches.

In another exemplary embodiment of the present invention, the binder contains a crosslinking agent to provide additional strength and to enhance the resistance of the chopped strand mat to styrene monomers.

In yet another exemplary embodiment of the present invention, the chopped strand mat provides for a smooth, soft surface to the pultruded part that is not achieved by a continuous filament mat.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a processing line for forming a chopped strand mat utilizing a wet-laid process according to at least one exemplary embodiment of the present invention;

FIG. 2 is a schematic illustration of a pultrusion process utilizing a chopped strand according to at least one exemplary embodiment of the present invention;

FIG. 3 is a graphical illustration of the effect on stiffness caused by the addition of 25% crosslinking agent;

FIG. 4 is a graphical illustration of the stiffness in the cross machine direction (CMD) for a conventional chopped strand mat and chopped strand mats having thereon inventive binder compositions containing and excluding a crosslinking agent according to exemplary embodiments of the present invention;

FIG. 5 is a graphical illustration of the stiffness in the machine direction (MD) for a conventional chopped strand mat and chopped strand mats having thereon inventive binder compositions containing and excluding a crosslinking agent according to exemplary embodiments of the present invention;

FIG. 6 is a graphical illustration of the retention of tensile strength in the machine direction (MD) for chopped strand mats having thereon inventive binder compositions containing and excluding a crosslinking agent according to exemplary embodiments of the present invention after exposure to styrene; and

FIG. 7 is a graphical illustration of the retention of tensile strength in the cross machine direction (CMD) for chopped strand mats having thereon inventive binder compositions containing and excluding a crosslinking agent according to exemplary embodiments of the present invention after exposure to styrene.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element, or intervening elements may be present. It is also to be understood that the term “web” and “mat” may be used interchangeably herein. Additionally, the terms “binder”, “binder composition”, and “composition” may be used interchangeably herein. The terms “mat” and “chopped strand mat” may also be interchangeably used herein.

The present invention is directed to soft, flexible, nonwoven mats that may be utilized in a pultrusion process to form reinforced composite parts. The nonwoven mats are at least partially coated with a binder composition that includes a binder resin, a silane coupling agent, an antifoaming agent, and optionally, a crosslinking agent. The softness and flexibility of the inventive mats enables the formation of pultruded products having complex shapes. Additionally, the inventive chopped strand mats are resistant to styrene monomers present in the resin utilized in pultrusion processes. The binder compositions of the present invention may utilized in a conventional (wet) chopped strand mat forming process without having to change process parameters such as oven drying time, conveyor speed, etc. In addition, the inventive binder composition may be applied to the chopped strand mat in conventional wet-laid mat manufacturing lines without a modification of the existing equipment. Further, the binder is desirably substantially free of formaldehyde. As used herein, the phrase “substantially free of formaldehyde” is meant to denote that the binder is free or nearly free of formaldehyde.

The glass fibers used to form the chopped strand glass mats may be any type of glass fiber, such as A-type glass fibers, C-type glass fibers, E-type glass fibers, S-type glass fibers, E-CR-type glass fibers (for example, Advantex® glass fibers commercially available from Owens Corning), wool glass fibers, or combinations thereof, In at least one embodiment, the glass fibers are wet use chopped strand glass fibers (WUCS). Wet use chopped strand glass fibers for use as the reinforcement fibers may be formed by conventional processes known in the art. It is desirable that the wet use chopped strand glass fibers have a moisture content from about 5 to about 30%, and even more desirably a moisture content from about 5 to about 15%. In addition, the presence of reinforcement fibers improves the wet strength of the mat prior to curing the binder. Wet use chopped strand glass fibers are a low cost reinforcement that provides impact resistance, dimensional stability, and surface smoothness.

The use of other reinforcing fibers such as mineral fibers, carbon fibers, ceramic fibers, natural fibers, and/or synthetic fibers in the chopped strand glass mat is considered to be within the purview of the invention. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include basalt, cotton, jute, bamboo, ramie, bagasse, hemp, coir, linen, kenaf, sisal, flax, henequen, and combinations thereof. The term “synthetic fibers” as used herein is meant to indicate any man-made fiber having suitable reinforcing characteristics, such as polyester, polyethylene, polyethylene terephthalate, polypropylene, polyamide, aramid, and/or polyaramid fibers. In exemplary embodiments, all of the fibers in the chopped strand mat are glass fibers.

The glass fibers may be formed by conventional methods known to those of skill in the art. For example, the glass fibers may be formed by attenuating streams of a molten glass material from a bushing or orifice. The attenuated glass fibers may have diameters of about 5 to about 30 microns, preferably from about 10 to about 20 microns. After the glass fibers are drawn from the bushing, an aqueous sizing composition is applied to the fibers. The sizing composition is not limited, and may be any sizing known to those of skill in the art. The sizing may be applied by conventional methods such as by an application roller or by spraying the size directly onto the fibers. The size protects the glass fibers from breakage during subsequent processing, helps to retard interfilament abrasion, and ensures the integrity of the strands of glass fibers, for example, the interconnection of the glass filaments that form the strand.

After the fibers are treated with the sizing composition, they may be chopped and packaged in their wet condition as wet use chopped strand glass (WUCS) and processed into a wet-laid chopped strand mat as described below. The chopped fibers may have a length from about 0.5 to about 2.0 inches. In exemplary embodiments, the chopped fibers have a length from about 1.0 to about 1.5 inches. The chopped fibers may have varying lengths and diameters from each other within the chopped strand mat. Although any or a combination of the reinforcing fibers described herein may be used to form a chopped strand mat, it is to be noted that the processes described herein are described with respect to an exemplary embodiment in which the reinforcement fibers in the chopped strands are glass fibers.

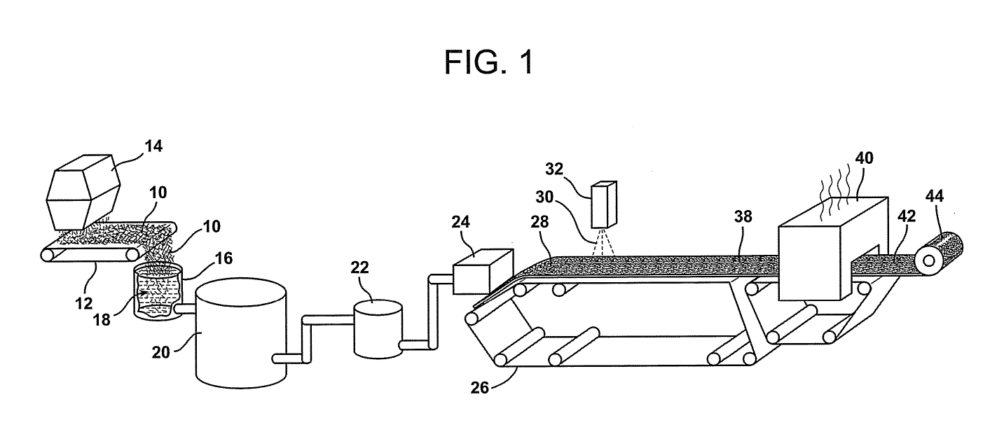

An exemplary process of forming the chopped strand mat utilizing the inventive binder composition is illustrated in FIG. 1. The chopped glass bundles 10 may be provided to a conveyor 12 by a storage container 14 the chopped glass fiber strands 10 are placed into a white water chest 16 that contains various surfactants, viscosity modifiers, defoaming agents, lubricants, biocides, and/or other chemical agents with agitation to form a chopped glass fiber slurry 18 in which the glass fibers released from the chopped glass fiber strands 10 are dispersed. It is desirable that the slurry 18 is agitated sufficiently to provide a uniform or nearly uniform dispersion of glass fibers. The white water may have a viscosity from about 1 to 20 cps, although it is to be appreciated that the viscosity is ultimately dependent upon the process parameters of the wet-laid process.

The slurry 18 may be passed through a machine chest 20 and a constant level chest 22 to further disperse the fibers released from the chopped glass strands 10. The glass fiber slurry 18 is transferred from the constant level chest 22 to a head box 24 where the slurry 18 is deposited onto a moving screen or foraminous conveyor 26 to form a web 28 of enmeshed glass fibers. The inventive binder composition 30 is then applied to the web 28 by a binder applicator 32, such as a curtain coater or spray applicator.

As discussed above, the inventive binder composition contains a binder resin, a coupling agent, and an antifoam agent. In some exemplary embodiments, a crosslinking agent may be included in the binder composition. The binder resin may be a thermoset acrylic polymer or styrene acrylate. In exemplary embodiments, the binder resin is a thermoset acrylic resin. Non-limiting examples of suitable resins for use in the composition include EXP-4355, a styrene acrylate resin (commercially available from Rohm and Haas), FG-472X, a urea formaldehyde resin (commercially available Hexion), and Rhoplex™ GL-618 an acrylic/polymer emulsion (commercially available from Hexion), polyacrylic acid, polyvinyl acetate, polyurethanes, modified starches, acrylates, and epoxy emulsions. The binder resin may be present in the binder composition in an amount from about 90 to about 99% by weight of the total binder composition, and in exemplary embodiments, from about 97 to about 99% by weight. As used herein, the phrase “% by weight” and “% by weight of the composition” is meant to denote percent by weight of the total components of the composition. It is to be noted, however, that when a crosslinking agent is added to the binder composition, the binder resin may be present from about 60 to about 90% by weight, and in exemplary embodiments, from about 70 to about 75%.

The binder composition also includes at least one coupling agent. It is to be appreciated that the coupling agents described below are exemplary in nature, and that any suitable coupling agent identified by one of skill in the art may be utilized in any of the embodiments described herein. The coupling agent or coupling agents (for example, coupling agent package) may be present in the binder composition (with or without the presence of a crosslinking agent) in an amount from about 1.0% to about 10.0% by weight of the total binder composition, and in exemplary embodiments, in an amount from about 1.0% to about 3.0% by weight. Besides their role of coupling the surface of the reinforcement fibers and the plastic matrix, silanes also function to reduce the level of fuzz, or broken fiber filaments, during subsequent processing.

In one or more exemplary embodiments, at least one of the coupling agents is a silane coupling agent. The silane coupling agent(s) may include silanes containing one or more nitrogen atoms that have one or more functional groups such as amine (primary, secondary, tertiary, and quaternary), amino, imino, amido, imido, ureido, or isocyanato. Suitable silane coupling agents include, but are not limited to, aminosilanes, silane esters, vinyl silanes, methacryloxy silanes, epoxy silanes, sulfur silanes, ureido silanes, and isocyanato silanes. Specific, non-limiting examples of silane coupling agents for use in the instant invention include γ-methacryloxypropyl-trimethoxysilane (A-174), γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxy silane (A-188), methyltrimethoxysilane (A-1630). Other examples of suitable silane coupling agents for are set forth in Table 1. All of the silane coupling agents identified above and in Table I, with the exception of methacryloxypropyl trimethoxy silane (Z-6030 (commercially available from Dow Corning)), are available commercially from GE Silicones.

TABLE 1

| Silanes | Label |
|---|---|
| Silane Esters | |
| Octyltriethoxysilane | A-137 |
| Methyltriethoxysilane | A-162 |
| Methyltrimethoxysilane | A-163 |
| Vinyl Silanes | |
| Vinyltriethoxysilane | A-151 |
| Vinyltrimethoxysilane | A-171 |
| vinyl-tris-(2-methoxyethoxy) silane | A-172 |
| Methacryloxy Silanes | |
| methacryloxypropyl trimethoxy | Z-6030 |
| silane | |
| Epoxy Silanes | |
| β-(3,4-epoxycyclohexyl)- | A-186 |
| ethyltrimethoxysilane | |
| Sulfur Silanes | |
| γ-mercaptopropyltrimethoxysilane | A-189 |
| Amino Silanes | |
| γ-aminopropyltriethoxysilane | A-1101 |
| | A-1102 |
| Aminoalkyl silicone | A-1106 |
| γ-aminopropyltrimethoxysilane | A-1110 |
| triaminofunctional silane | A-1130 |
| bis-(γ-trimethoxysilylpropyl)amine | A-1170 |
| polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

In at least one exemplary embodiments, the silane coupling agent includes a methacryloxy silane.

The binder composition may also contain a trace amount of a weak organic acid such as acetic acid, formic acid, succinic acid, and/or citric acid hydrolyze the silane in the coupling agent. It is preferred that the organic acid is acetic acid. The organic acid may be present in the binder composition in an amount from about 0.1 to about 1.0% by weight of the binder composition, or from about 0.3 to about 0.6% by weight.

Additionally, the binder desirably contains an antifoaming agent to reduce the amount of foam during the application of the binder composition. The antifoam agent is hydrocarbon-based, and may be a hydrocarbon oil antifoam additive. Examples of suitable antifoaming agents include, but are not limited to, Foam Blast 307A, a hydrocarbon-based defoaming agent commercially available from Emerald), GEO FM 111, hydrocarbon oil defoamer (commercially available from GEO), Nalco PPO43840 and PPO30378, hydrocarbon-based defoamers (commercially available from Ondeo Nalco Company), and mineral oils (with or without varying carbon blends). The antifoaming agent may be present in the composition in an amount from 0.01 to about 2.0% by weight of the composition, and in exemplary embodiments, from about 0.1 to about 0.15% by weight. It is to be appreciated that under circumstances where foaming of the binder may not be an issue, the antifoaming agent may be utilized as an optional component.

In some exemplary embodiments, the binder composition contains a crosslinking agent. The crosslinking agent provides additional strength to the chopped strand mat and an improved resistance to styrene. The chopped strand mat of the present invention, when used in a pultrusion process described below, encounters styrene monomers that can easily swell and degrade the binder to a point where the mat is unable to resist forces that act upon it and may disrupt the pultrusion process. It has been discovered that the addition of one or more crosslinking agent enhances resistance to the styrene monomers, enabling the mat to withstand the high pulling forces encountered in a pultrusion process. The crosslinking agent may be a resin-based crosslinking agent. Suitable examples of crosslinking agents for use in the present invention include QR-1629S, a polyacrylic acid/glycerin mixture (commercially available from Rohm and Haas), urea-formaldehyde mixtures, N methyl acrylamide (NMA), and the like. The crosslinking agent may be present in the binder composition in an amount from about zero to about 40% by weight of the composition, or from about 10.0% to about 40% by weight of the composition. In exemplary embodiments, the crosslinking agent is present from about 20% to about 25% by weight.

The binder may optionally contain conventional additives for the improvement of process and product performance such as dyes, oils, fillers, colorants, UV stabilizers, lubricants, wetting agents, surfactants, and/or antistatic agents. Additives may be included in the binder composition in from 0.0% to about 10% by weight of the binder composition.

The binder composition further includes water to dissolve or disperse the components for application onto the reinforcement fibers. Water may be added in an amount sufficient to dilute the aqueous binder composition to a viscosity that is suitable for its application to the reinforcement fibers. In particular, the size composition may contain from about 50% to about 75% by weight of the binder composition of water.

Turning back to FIG. 1, after the binder 30 has been applied to the web 28, a vacuum system (not shown) removes excess binder and white water from the web 28. The binder-coated web 38 is passed through one or more drying ovens 40 to remove any remaining water and cure the binder 30. The uncured binder functions to improve the strength of the wet-laid mat as it is transported from the head box 24 through the curing oven 40. The cured binder provides integrity and flexibility to the glass mat 42. The nonwoven chopped strand mat 42 may be rolled onto a take-up roll 44 for storage for later use, such as in a pultrusion process to form a reinforced composite part.

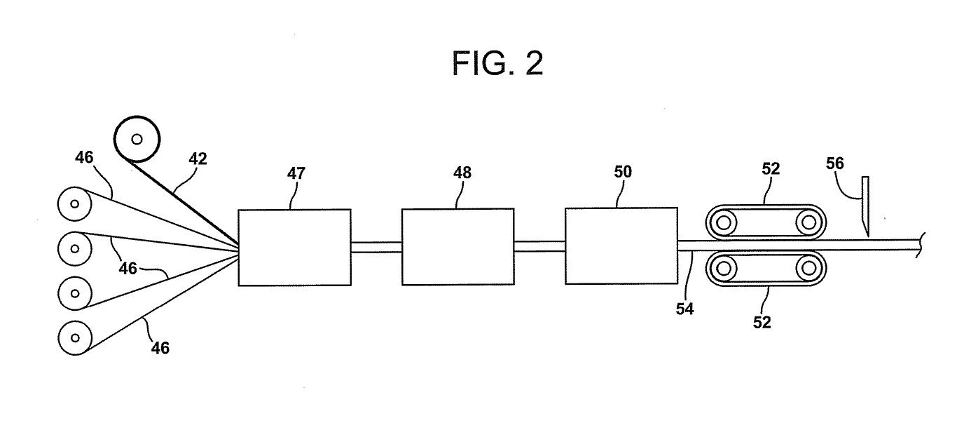

In a pultrusion process, such as is generally depicted in FIG. 2, glass rovings 46 and at least one chopped strand mat 42 are fed into a thermosetting resin bath 47 where the rovings are moved over spreader bars which aid in impregnating the resin into the glass fibers. Once the rovings 46 are sufficiently impregnated with the resin, the rovings 46 and the chopped strand mat 42 exit the resin bath and are pre-formed by a pre-former 48 into a shape or profile prior to entering a molding die 50. The rovings 46 and chopped strand mat 42, which have the pre-formed shape, are then cured into the desired form of the composite by heating continuously as the part passes through the heated die 50. A pair of caterpillar rollers 52 may be used to pull the rovings 46 and mat 42 through the bath, pre-former, and heated die 50. The composite part 54 exiting the heated die 50 is then cut to a desired length. In this manner, the continuous roving 46 is impregnated with a polymer resin, the mat 42 is coated with the resin, and the fibers 46 and mat 42 are shaped into the form of the composite and cut by a cutting apparatus 56. The rovings provide a longitudinal tensile strength and the chopped strand mat 42 provides a transverse tensile strength to the pultruded part.

As discussed above, the binder composition containing the crosslinking agent provides improved resistance to styrene monomers present in the thermosetting resin in pultrusion processes. This resistance to styrene makes the inventive mats particularly suitable for pultrusion processes. As discussed above, styrene monomers are a potent solvent and can act to swell and degrade the binder, thereby weakening the continuity of the mat. By providing a chopped strand mat resistant to styrene monomers, the chopped strand mat, and thus the pultruded part, maintain tensile strength in the transverse direction as well as in the longitudinal direction.

The binder composition also provides for a soft mat, especially when compared to conventional pultrusion mats, and can easily be conformed and shaped to form complex molded parts. Additionally, the use of a chopped strand mat in a pultrusion process provides a reduction in manufacturing costs for the pultruded part. Continuous filament mats conventionally used in pultrusion processes are more costly to manufacture that wet-laid chopped strand mats. In addition, the chopped strand mat provides for a smooth, soft surface to the pultruded part that is not achieved by the continuous filament mat.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Binder Composition without Crosslinking Agent

The components and amounts for the binder composition are set forth in Table 2. To form the binder composition, the silane coupling agent was slowly added to 150 ml of acetic acid (to a pH less than 4) with stirring into a mix tank. The silane mixture was permitted to agitate for 30 minutes. After 30 minutes, it was determined that the hydrolysis was not complete. 100 ml of acetic acid was added and the mixture was stirred for an additional 30 minutes. Once hydrolysis was complete, the binder resin was added slowly to the silane mixture with stirring. This mixture was permitted to agitate for about 5 minutes. Next, the defoaming agent was added to the mix tank. The resulting mixture was permitted to mix for 15 minutes to form the binder composition.

TABLE 2

| | 750 gal | | |
|---|---|---|---|
| | mix | | |
| Material | (lbs) | Actual Loading | |
| Batch size | | 1000 | gal |
| EXP-4355⁽¹⁾ | 4,079 | 4,035 | lb |
| Water | 1,629 | 1,629 | gal |
| Acetic Acid | 100 mL | 100 + 150 | ml |
| Coupling Agent⁽²⁾ | 48 | 48 | lb |
| Antifoaming | 2.75 | 2 | lb |
| Agent⁽³⁾ | | | |
| Water Spray | 500 | 250 | lb |

| Property | Target | Batches 1 and 2 |
|---|---|---|
| Solids | 30% | 22.90%, 21.80% |
| Viscosity | measure | 6.3, 6 |
| pH | measure | 6.2, 6.3 |

⁽¹⁾a styrene acrylate resin (commercially available from Rohm and Haas)
⁽²⁾γ-methacryloxypropyl-trimethoxysilane (commercially available from GE Silicones
⁽³⁾hydrocarbon oil-based defoamer (commercially available from GEO)

### Example 2

### Wet-Laid Chopped Strand Mat with Binder Composition Containing No Crosslinking Agent

The binder composition of Example 1 was used as a binder in a wet-laid process as described in detail above. The following parameters were utilized:
White water 98° F.
Mix Tank 65° F.
Seal Tank 79° F.
Line Speed 400 fpm (feet per minute) and 426 fpm
Oven set points: (zones 1, 2, and 3, respectively) 465° F., 469° F., and 500° F.

It was noted that the mats had a very “soft” touch and “quilted” when compacted. Data obtained from the mat are set forth in Table 3.

TABLE 3

| Ave. | | Ave. | Ave. | | | | | Ave. |
|---|---|---|---|---|---|---|---|---|
| Basis | | Tensile | Tensile | Ave. | | Ave. | Ave. | Tensile |
| Weight | Ave. | Strength | Strength | Tensile | Ave. | Air | Tensile | Hot/Dry |
| (ft²) | LOI | (MD) | (CD) | Ratio | Caliper | Perm | Hot/Dry | (%) |
| 2.31 | 10.66 | 26.4 | 19.09 | 1.38 | 40.90 | 712.63 | 16.11 | 61.03 |
| 2.25 | 10.36 | 27.55 | 19.76 | 1.39 | 39.10 | 726.75 | 16.48 | 59.80 |
| 2.52 | 10.23 | 25.60 | 19.95 | 1.26 | 43.06 | 674.88 | 15.62 | 61.03 |
| 3.00 | 9.90 | 29.66 | 20.95 | 1.42 | 49.60 | 610.63 | 17.27 | 58.23 |
| 2.29 | 9.76 | 22.35 | 15.13 | 1.48 | 39.20 | 708.88 | 19.02 | 85.12 |
| 2.27 | 12.16 | 30.53 | 26.13 | 1.17 | 38.90 | 694.63 | 20.40 | 68.84 |
| 2.29 | 10.83 | 26.80 | 16.14 | 1.66 | 37.30 | 763.25 | 16.41 | 61.24 |

### Example 3

### Binder Composition Containing Crosslinking Agent

The components and amounts for the binder composition are set forth in Table 4. The crosslinking agent (a pH about 3.5 to about 4.0) was added to a first mixing tank containing water with agitation. Next, the silane coupling agent was slowly added to the first mixing tank while stirring. The silane mixture was agitated in the first mixing tank until hydrolysis of the silane was complete. Water was then added to a second mixing tank. The silane mixture from the first mixing tank was then added to the water in the second mixing tank with agitation. The resulting mixture was permitted to mix for about 10 minutes. Next, the binder resin and antifoaming agent were sequentially added to the second mix tank with agitation to form the binder composition.

TABLE 4

| | | Lower | | |
|---|---|---|---|---|
| | | limit | Upper | |
| | 750 gal | (lbs) | limit (lbs) | Actual |
| Material | mix (lbs) | (3%) | (3%) | Loading |
| Batch Size | | | | 750 lbs |
| EXP-4355⁽¹⁾ | 3,024 | 2,933 | 3,115 | 3224 |
| Crosslinking Agent⁽²⁾ | 996 | 966 | 1,026 | 993 |
| Water | 1,665 | 1,615 | 1,715 | 1662 |
| Coupling Agent⁽³⁾ | 48 | 46 | 49 | 48 |
| Antifoaming Agent⁽⁴⁾ | 2.75 | 2.67 | 2.83 | 2.75 |
| Water Spray | 500 | 485 | 515 | 0 |
| Property | Target | | | |
| Solids | 30% | | | 31.0% |
| Viscosity | measure | | | 8.5 |
| pH | measure | | | 4.4 |

⁽¹⁾a styrene acrylate resin (commercially available from Rohm and Haas)
⁽²⁾polyacrylic acid/glycerin mixture (commercially available from Rohm and Haas)
⁽³⁾γ-methacryloxypropyl-trimethoxysilane (commercially available from GE Silicones
⁽⁴⁾hydrocarbon oil-based defoamer (commercially available from GEO)

### Example 4

### Binder Composition Containing Crosslinking Agent

The binder composition of Example 3 was used as a binder in a wet-laid process as described in detail above. The following parameters were utilized:
White water 98° F.
Mix Tank 65° F.
Seal Tank 80° F.
Line Speed 350 fpm (feet per minute)
Oven set points: (zones 1, 2, and 3, respectively) 465° F., 469° F., and 525° F.

It was observed that the mats were slightly stiffer and more apt to crease than the mats produced in Example 2. Data obtained from the mat are set forth in Table 5.

TABLE 5

| Ave. | | Ave. | Ave. | | | | | Ave. |
|---|---|---|---|---|---|---|---|---|
| Basis | | Tensile | Tensile | Ave. | | Ave. | Ave. | Tensile |
| Weight | Ave. | Strength | Strength | Tensile | Ave. | Air | Tensile | Hot/Dry |
| (ft²) | LOI | (MD) | (CD) | Ratio | Caliper | Perm | Hot/Dry | (%) |
| 3.10 | 10.58 | 55.21 | 44.69 | 1.23 | 65.13 | 607.25 | 52.83 | 95.69 |
| 2.88 | 10.09 | 41.97 | 31.80 | 1.32 | 55.10 | 601.88 | 25.08 | 59.76 |
| 2.91 | 12.10 | 49.62 | 40.06 | 1.24 | 54.70 | 624.75 | 27.23 | 54.69 |

### Example 5

### Mat Stiffness

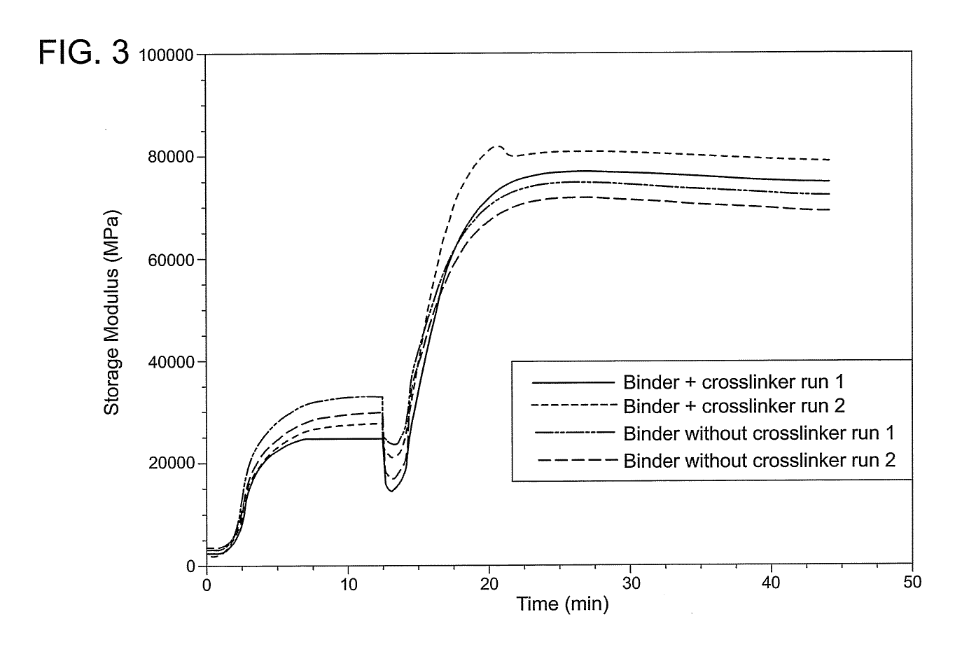

The stiffness of sample mats coated with the binders of the invention was tested according to TAPPI Method 543 om-00 employing a “Gurley Stiffness Tester”, FIG. 3 is a summary of four dynamic mechanical analyses (DMA) experiments. The DMA experiments represent replicate samples that were scanned according to the method below. The tester was a TA Instruments Dynamic Mechanical Analyzer, DMA Q800.
1. 0.5 at room temperate
2. 50° C./min ramp to 110° C.—hold 10 minutes
3. 50° C. ramp to 250° C. hold for 30 minutes
   The results indicated a slight stiffening of the inventive binder that contained the crosslinking agent. It was concluded from this experiment that there are differences in the inherent stiffness of the binder mixtures.

### Example 6

### Stiffness and Retention Strength After Exposure to Styrene

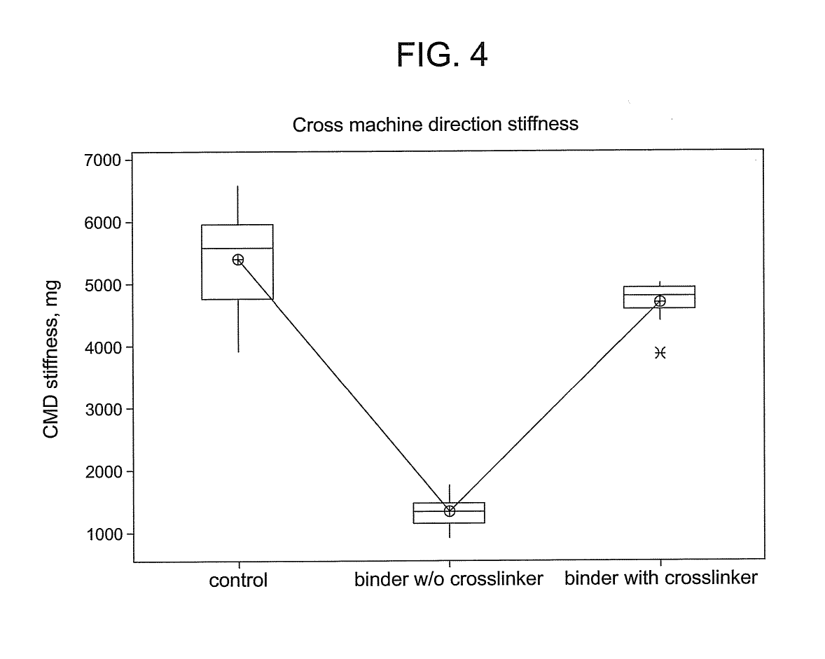

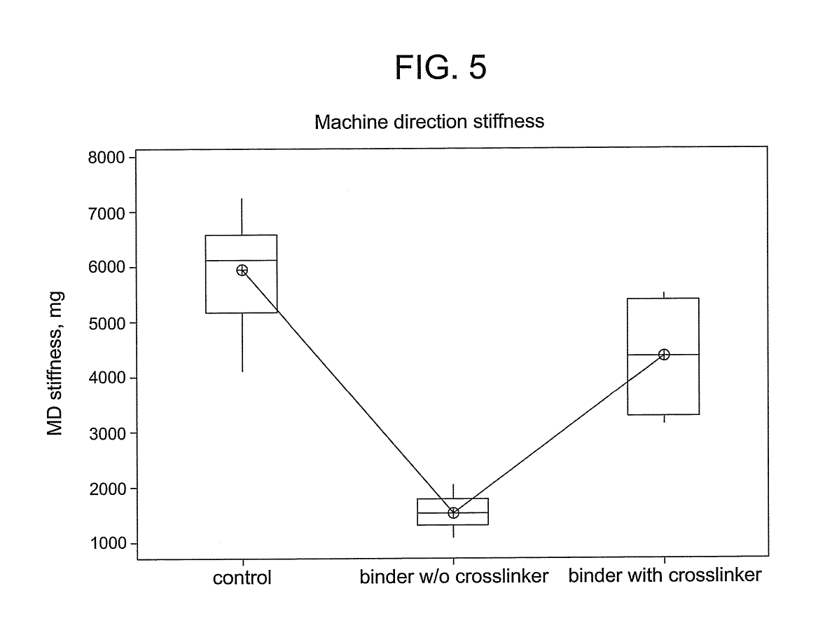

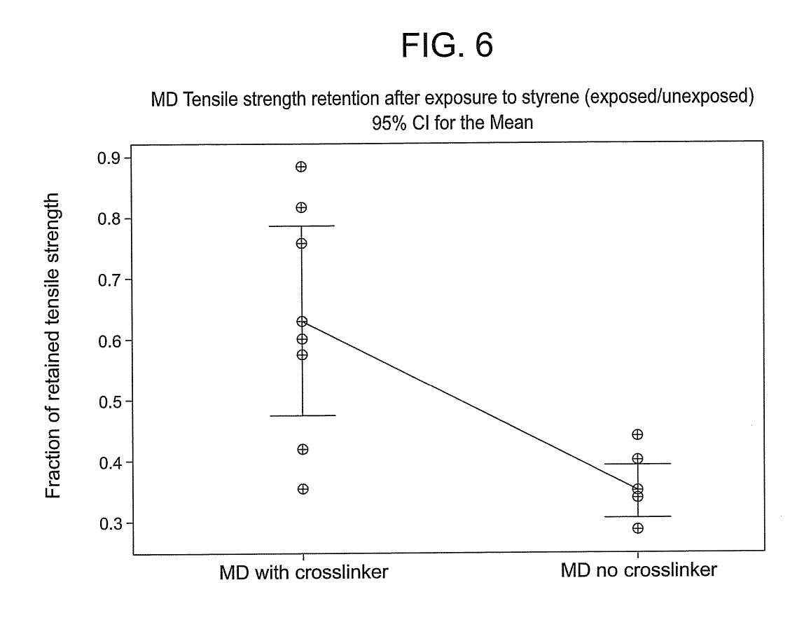

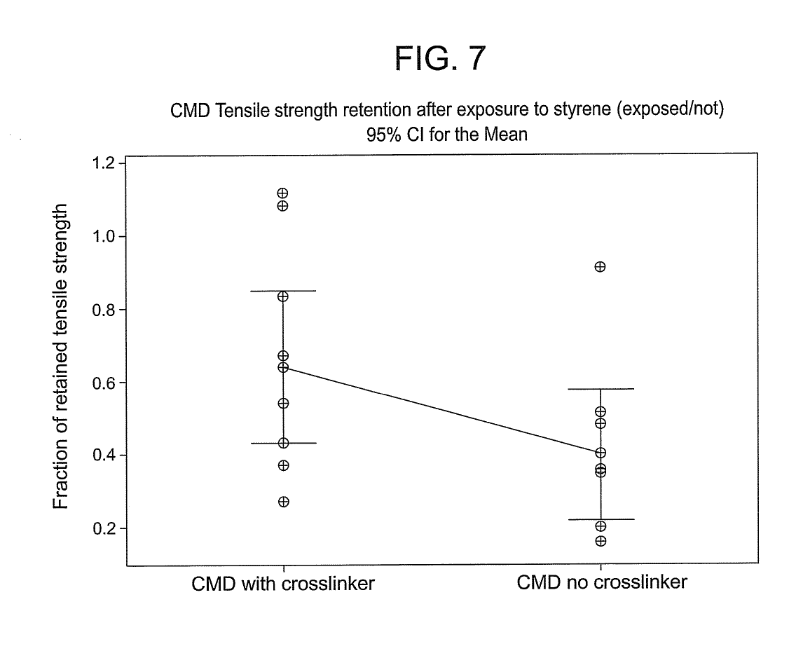

Tests to determine the stiffness of sample mats coated with the inventive binders as well the retention strength of sample mats coated with the inventive binders after exposure to styrene were conducted. In particular, the dry mat tensile strength was tested in an Instron tensile tester to determine the dry tensile strength. The mats were then soaked in styrene monomer for 10 minutes. After the soaking period, the mats were patted dry with paper towels and pulled by an Instron machine to determine the tensile strength after styrene exposure. FIGS. 4 and 5 illustrate the stiffness and FIGS. 6 and 7 illustrate the retention strength in styrene for sample mats according to the invention.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

What is claimed is:

1. A binder composition for reinforcement fibers used to form wet-laid chopped strand mats for use in pultrusion processes, said binder composition comprising:
a thermosetting binder resin;
a silane coupling agent; and
a hydrocarbon-based antifoaming agent.

2. The binder composition of claim 1, further comprising a crosslinking agent.

3. The binder composition of claim 2, wherein said crosslinking agent is a resin-based crosslinking agent.

4. The binder composition of claim 1, wherein said silane coupling agent is a methactyloxy silane.

5. The binder composition of claim 1, wherein said binder resin is selected from the group consisting of acrylic polymers, styrene acrylates, polyacrylic acid, polyvinyl acetate, polyurethanes, modified starches, acrylates, epoxy emulsions, urea formaldehyde and mixtures thereof.

6. The binder composition of claim 5, wherein said binder resin is selected from the group consisting of acrylic polymers, styrene acrylates and mixtures thereof

7. The binder composition of claim 5, wherein said hydrocarbon-based antifoaming agent is a hydrocarbon oil antifoaming agent.

8. The binder composition of claim 1, wherein:
said binder resin is present in said composition in an amount from about 60% to about 90% by weight of the total composition;
said silane coupling agent is present in said composition in an amount from about 1.0% to about 10% by weight of the total composition;
said antifoaming agent is present in said composition in an amount from about 0.1% to about 5.0% by weight of the total composition; and
wherein said composition includes a resin-based crosslinking agent in an amount from zero to 40% by weight of the total composition.

9. A wet-laid chopped strand mat for use in a pultrusion process comprising;
a plurality of randomly dispersed chopped reinforcement fibers bound together by a binder including:
a thermosetting binder resin;
a silane coupling agent; and
a hydrocarbon-based antifoaming agent.

10. The wet-laid chopped strand mat of claim 9, wherein said binder resin is selected from the group consisting of acrylic polymers, styrene acrylates, polyacrylic acid, polyvinyl acetate, polyurethanes, modified starches, acrylates, epoxy emulsions, urea formaldehyde and mixtures thereof.

11. The wet-laid chopped strand mat of claim 10, wherein said binder resin is selected from the group consisting of acrylic polymers, styrene acrylates and mixtures thereof

12. The wet-laid chopped strand mat of claim 11, wherein said silane coupling agent is a methacryloxy silane.

13. The wet-laid chopped strand mat of claim 11, wherein said hydrocarbon-based antifoaming agent is a hydrocarbon oil antifoaming agent.

14. The wet-laid chopped strand mat of claim 13, wherein said composition further comprises a crosslinking agent.

15. The wet-laid chopped strand mat of claim 14, wherein said crosslinking agent is a resin-based crosslinking agent.

16. The wet-laid chopped strand mat of claim 14, wherein said crosslinking agent provides additional strength to said chopped strand mat and enhances the resistance of the chopped strand mat to styrene monomers, said resistance maintaining tensile strength of said wet-laid chopped strand mat in a transverse direction and in a longitudinal direction.

17. The wet-laid chopped strand mat of claim 11, wherein said chopped strand mat is flexible to enable the formation of pultruded products having complex shapes.

18. A pultruded part having a complex shape comprising:
a plurality of rovings impregnated with a thermosetting resin; and
a wet-laid nonwoven chopped strand mat having thereon a binder composition, said wet-laid nonwoven chopped strand mat and said plurality of rovings being consolidated and pultruded into said complex shape,
wherein said binder composition includes:
a thermosetting binder resin selected from the group consisting of acrylic polymers, styrene acrylates, polyacrylic acid, polyvinyl acetate, polyurethanes, modified starches, acrylates, epoxy emulsions, urea formaldehyde and mixtures thereof;
a silane coupling agent; and
a hydrocarbon-based antifoaming agent.

19. The pultruded part of claim 18, wherein said binder resin is selected from the group consisting of acrylic polymers, styrene acrylates and mixtures thereof, and
wherein said composition further comprises a crosslinking agent.

20. The pultruded part of claim 19, wherein said hydrocarbon-based antifoaming agent is a hydrocarbon oil antifoaming agent and said coupling agent is a methacryloxy silane coupling agent.

21. A binder composition for reinforcement fibers used to form wet-laid chopped strand mats for use in pultrusion processes comprising:
a thermosetting binder resin selected from acrylic polymers and styrene acrylates; and
a methacryloxy silane coupling agent.

22. The binder composition of claim 21, further comprising one or more members selected from a resin-based crosslinking agent and a hydrocarbon-based antifoaming agent.

23. The binder composition of claim 22, wherein said binder composition provides a resistance to styrene monomers,
